(19) United States
(12) Patent Application Publication
(10) Pub. No.: US 2014/0059011 A1
(43) Pub. Date: Feb. 27, 2014

(54) AUTOMATED DATA CURATION FOR LISTS

(71) Applicants: JAMES E. BOSTICK, CEDAR PARK, TX (US); JOHN M. GANCI, JR., CARY, NC (US); JOHN P. KAEMMERER, PFLUGERVILLE, TX (US); CRAIG M. TRIM, SYLMAR, CA (US)

(72) Inventors: JAMES E. BOSTICK, CEDAR PARK, TX (US); JOHN M. GANCI, JR., CARY, NC (US); JOHN P. KAEMMERER, PFLUGERVILLE, TX (US); CRAIG M. TRIM, SYLMAR, CA (US)

(73) Assignee: INTERNATIONAL BUSINESS MACHINES CORPORATION, ARMONK, NY (US)

(21) Appl. No.: 13/595,654

(22) Filed: Aug. 27, 2012

(51) Int. Cl. G06F 17/30

(52) U.S. Cl. 707/687; 707/E17.005

(57) ABSTRACT

A processor-implemented method, system, and/or computer program product identifies errant data in an initial data list. An initial data list is composed of multiple data entries, where each of the data entries is associated with a parent hypernym from a group of multiple parent hypernyms. The parent hypernym describes a common attribute of data entries in the initial data list that have a same parent hypernym. A plurality parent hypernym is identified as a parent hypernym that is common to more data entries in the initial data list than any other parent hypernym. Any datum entry in the initial data list that is not associated with the plurality parent hypernym is then flagged for eviction from the initial data list.

### BACKGROUND

The present disclosure relates to the field of computers, and specifically to the use of databases in computers. Still more particularly, the present disclosure relates to the management of database lists.

A database is a collection of data. One type of collection of data is presented as a list, in which entries in the list are deemed to be related. If an errant entry is in the list (i.e., is not related to other items in the list), then the entire list may be deemed compromised and thus untrustworthy, if not inaccurate.

### SUMMARY

A processor-implemented method, system, and/or computer program product identifies errant data in an initial data list. An initial data list is composed of multiple data entries, where each of the data entries is associated with a parent hypernym from a group of multiple parent hypernyms. The parent hypernym describes a common attribute of data entries in the initial data list that have a same parent hypernym. A plurality parent hypernym is identified as a parent hypernym that is common to more data entries in the initial data list than any other parent hypernym. Any datum entry in the initial data list that is not associated with the plurality parent hypernym is then flagged for eviction from the initial data list.

### BRIEF DESCRIPTION OF THE SEVERAL VIEWS OF THE DRAWINGS

FIG. 1 depicts an exemplary system and network in which the present disclosure may be implemented;

FIG. 2 illustrates an exemplary data list in which data entries are associated with a parent hypernym and/or a parent holonym;

FIG. 3 depicts an exemplary data list in which data entries are associated with a parent hypernym and/or a grandparent hypernym;

FIG. 4 illustrates an exemplary data list in which data entries are associated with a parent holonym and/or a grandparent holonym;

FIG. 5 is a high-level flow chart of one or more steps performed by a computer processor to identify errant data entries for eviction from a data list by the use of hypernyms and/or holonyms.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

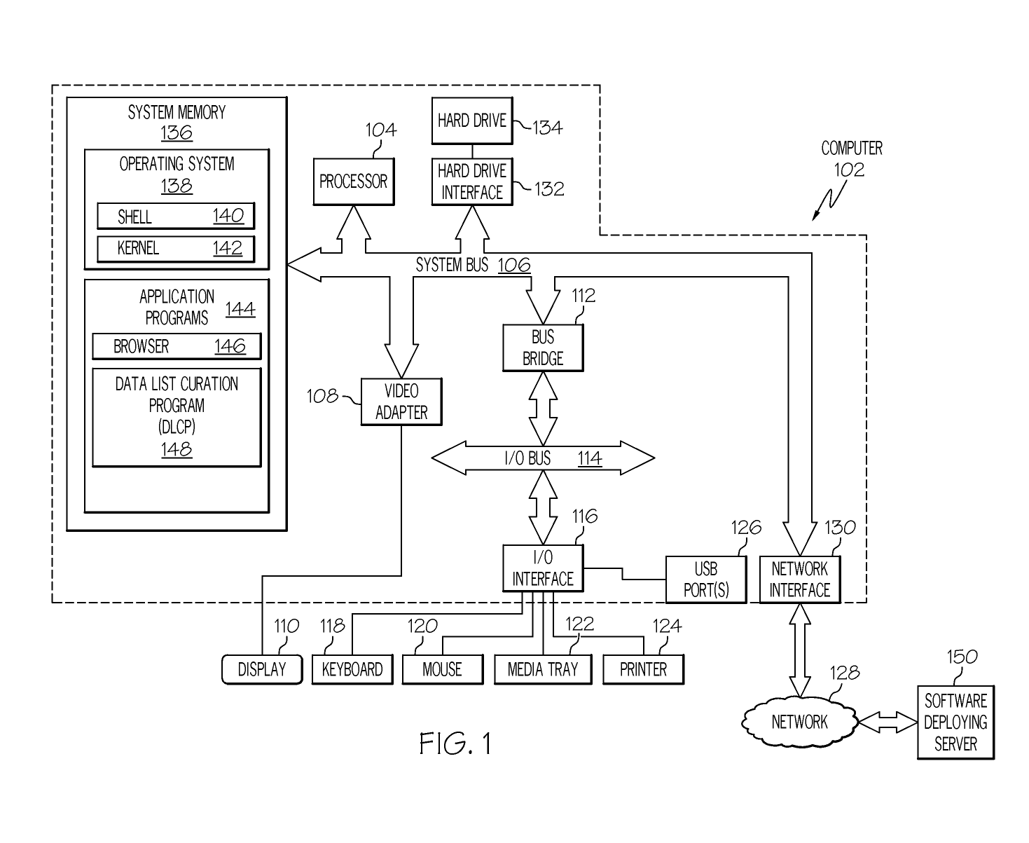

With reference now to the figures, and in particular to FIG. 1, there is depicted a block diagram of an exemplary system and network that may be utilized by and in the implementation of the present invention. Note that some or all of the exemplary architecture, including both depicted hardware and software, shown for and within computer 102 may be utilized by software deploying server 150.

Exemplary computer 102 includes a processor 104 that is coupled to a system bus 106. Processor 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150, using a network interface 130. Network interface 130 is a hardware network interface, such as a network interface card (NIC), etc. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102′s operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems.

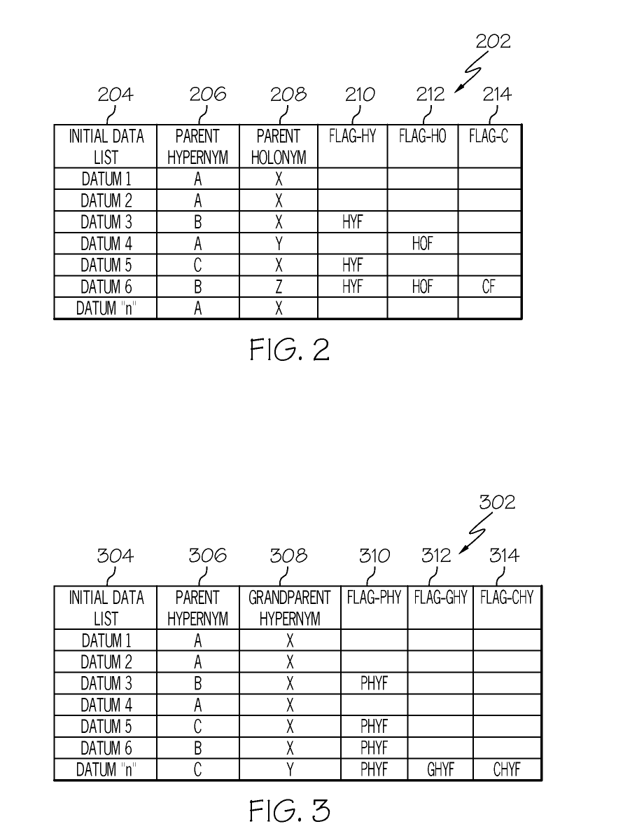

Application programs 144 in computer 102's system memory (as well as software deploying server 150's system memory) also include a data list curation program (DLCP) 148. DLCP 148 includes code for implementing the processes described below, including those described in FIGS. 2-5. In one embodiment, computer 102 is able to download DLCP 148 from software deploying server 150, including in an on-demand basis, wherein the code in DLCP 148 is not downloaded until needed for execution. Note further that, in one embodiment of the present invention, software deploying server 150 performs all of the functions associated with the present invention (including execution of DLCP 148), thus freeing computer 102 from having to use its own internal computing resources to execute DLCP 148.

Note that the hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

A hypernym is a word or phrase that describes a common relationship of hyponyms. This relationship is often referred to as an “is-a” relation. For example, “red” is a “color”, “blue” is a “color”, and “green” is a “color”. In this example, “color” is the hypernym, and “red”, “blue”, and “green” are hyponyms. Hypernyms can be manually assigned to hyponyms, or they can be automatically derived/generated using various algorithms known to those skilled in the art of semantics and taxonomy. For example, text data mining may identify a phrase such as “object X and other similar objects Y”. This phrase infers that “object X” is the hyponym of “objects Y” (where “Y” is the hypernym). Another example of hypernym determination is a lexical database such as WordNet, which groups words into synonyms called synsets.

A holonym is a word or phrase that is made up of meronyms. A “meronym” is often expressed as that which is “part-of' a “holonym”. For example, a “tree” is made up of “leaves”, “branches”, “bark”, and “roots”. In this example, “tree” is the holonym, and “leaves”, “branches”, “bark”, and “roots” are the meronyms that make up the holonym “tree”. A holonym can also be manually assigned to meronyms, or it can be derived from text mining. For example, assume that a catalog has a listing of all components of a particular piece of equipment. Data mining thus can reveal that the piece of equipment is the holonym, while all listed components are the meronyms.

With reference now to FIG. 2, an exemplary data list in which data entries are associated with a parent hypernym and/or a parent holonym is illustrated. More specifically, a table 202 contains an initial data list 204, which is composed of datum 1-datum “n” (where “n” is an integer). Associated with each datum in the initial data list 204 is a parent hypernym, as indicated by parent hypernym column 206. In one embodiment, a parent holonym is also associated with each datum in the initial data list 204, as indicated by parent holonym column 208. For example, assume that data in the initial data list 204 describe various units of equipment. More specifically, assume that datum 1 identifies a computer made by Company I; datum 2 identifies a computer made by Company II; datum 3 identifies an automobile made by Company III; datum 4 identifies a computer that is also made by Company I; datum 5 identifies a desk made by Company IV; datum 6 identifies an automobile made by Company V; and datum “n” identifies a computer made by Company VI. Assume further that hypernym A is “Computer”; hypernym B is “Vehicle”; and hypernym C is “Furniture”.

In the example described for FIG. 2, two scenarios exist. The first scenario is that it is known or assumed that initial data list 204 is to contain only names/identifiers of computers. The second scenario is that it is initially unknown what type of names/identifiers should populate the initial data list 204. In this second scenario, the type of names/identifiers that should populate the initial data list 204 is determined by a plurality rule, in which the most common type of names/identifiers is assumed to be correct. Thus, in the example shown in FIG. 2, hypernym A (“Computers”) occurs more often than any other hypernym in the table 202, and thus hypernym A is determined to be the plurality (i.e., occurs more often than any other) parent hypernym. If any datum in the initial data list 204 is not associated with hypernym A, then it is now assumed to be errant (i.e., does not truly belong in the initial data list 204), and is flagged accordingly for eviction or other actions. Thus, datum 3, datum 5, and datum 6 are all flagged with hypernym flags (HYF) shown in FLAG-HY column 210, indicating that they are not associated with the plurality parent hypernym A.

Similarly, a plurality parent holonym can be determined from the holonyms shown under parent holonym column 208. For example, assume that holonym X is a combination of all resources that are owned by an enterprise; holonym Y is a combination of all resources that are leased by the enterprise; and holonym Z is a combination of all resources that are inoperable (i.e., broken, inoperable, irreparable, etc.). In this example, enterprise-owned resources (holonym X) are the most common in the initial data list 204. Thus, holonym X is the plurality parent holonym. Any of the data in the initial data list 204 that is not part of holonym X is thus flagged with a HOF flag in FLAG-HO column 212, indicating that they are not part of the parent holonym X, and thus are candidates for eviction from the initial data list 204.

In the scenarios described above, a particular datum is flagged for eviction from the initial data list 204 if it is not associated with a plurality parent hypernym or a plurality parent holonym. In one embodiment, a particular datum is allowed to remain within the initial data list 204 unless it is not associated with both the plurality parent hypernym and the plurality parent holonym, in which case it is flagged with a combined flag (CF) in FLAG-C column 214.

With reference now to FIG. 3, an exemplary data list in which data entries are associated with a parent hypernym and/or a grandparent hypernym is depicted. For example, assume that a table 302 depicts datum 1-datum “n” in an initial data list 304, and that these datum 1-datum “n” name/identify various units of equipment. Assume further that, as depicted in parent hypernym column 306 that parent hypernym A describes computers; parent hypernym B describes routers; and parent hypernym C describes server blade chassis. Assume further that each of these parent hypernyms can also be described by broader hypernyms, known as grandparent hypernyms shown in grandparent hypernym column 308. For example, as shown in grandparent hypernym column 308, grandparent hypernym X describes electronic equipment, while grandparent hypernym Y describes mechanical equipment. Thus, datum 1, datum 2, and datum 4 all name/identify computers, and thus hypernym A is the plurality (i.e., more than any other) parent hypernym. However, datum 3, datum 5, and datum 6 also describe electronic equipment (as indicated by the common grandparent hypernym X, with which datum 1, datum 2, and datum 4 are also associated). Thus, the parent hypernym flags (PHYF) shown in FLAG-PHY column 310 may not been deemed significant for datum 1-datum 6. However, note that datum “n” is also identified by the parent hypernym C as being a blade chassis. As indicated by grandparent hypernym Y, however, this particular blade chassis lacks the requisite wiring/electronics to be considered electronic equipment, and is merely a mechanical (i.e., non-electronic) device. Thus, the device identified by datum “n” is flagged by a parent hypernym flag (PHYF) in FLAG-PHY column 310 and a grandparent hypernym flag (GHYF) in FLAG-GHY column 312, as indicated by the combined hypernym flag (CHYF) shown in FLAG-CHY column 314. In the example shown in FIG. 3, therefore, datum 3, datum 5, datum 6, and datum “n” are flagged for eviction from initial data list 304 based on the fine granularity provided by the parent hypernym flags PHYF, while only datum “n” would be evicted based on the coarser granularity provided by the grandparent hypernym flag GHYF and/or the combination hypernym flag CHYF.

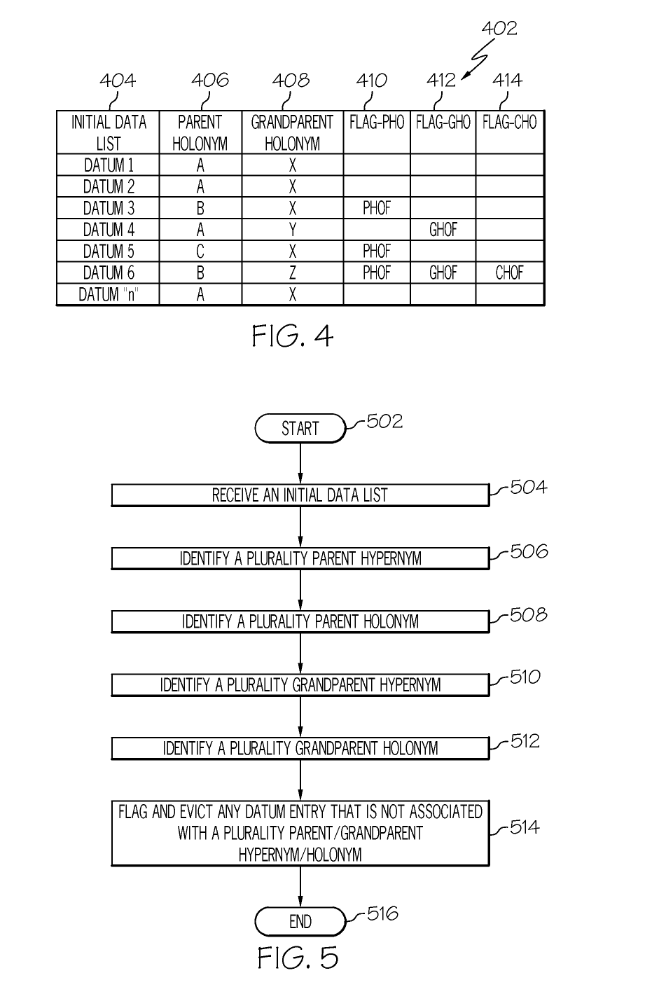

FIG. 4 illustrates an exemplary data list in which data entries associated with a parent holonym and/or a grandparent holonym are identified and/or flagged for eviction. For example, assume that a table 402 depicts datum 1-datum “n” in an initial data list 404, and that these datum 1-datum “n” again name/identify various components of computers. Assume further that, as depicted in parent holonym column 406, parent holonym A describes laptop computers; parent holonym B describes desktop computers; and parent holonym C describes servers. Assume further that each of these parent holonyms can also be described by broader holonyms, known as grandparent holonyms shown in grandparent holonym column 408. For example, as shown in grandparent holonym column 408, grandparent holonym X describes local area network (LAN) 1, while grandparent holonym Y describes LAN 2, and grandparent holonym Z describes LAN 3. Thus, datum 1, datum 2, and datum 4 all name/identify laptop computers, and thus holonym A is the plurality (i.e., more than any other) parent holonym. However, datum 3, datum 5, and datum “n” are also part of LAN 1, making grandparent holonym X the plurality (i.e., most common) grandparent holonym shown in grandparent holonym column 408. Thus, the parent holonym flags (PHOF) shown in FLAG-PHO column 410 may not been deemed significant for datum 3 and datum 5, since they are also part of LAN 1. However, note that datum 4 is identified by the grandparent holonym Y as being in LAN 2 (and thus flagged with the grandparent holonym flag (GHOF) in FLAG-GHO column 412), and thus is a likely candidate for eviction from initial data list 404, which is now deemed to be specific for components of LAN 1. Furthermore, datum 6 is certainly a candidate for eviction from initial data list 404, since it is not a laptop (indicated by the PHOF flag in FLAG-PHO column 410), and is not part of LAN 1 (as indicated by the GHOF flag in FLAG-GHO 412), which is emphasized by the combined holonym flag (CHOF) shown in FLAG-CHO column 414. In the example shown in FIG. 4, therefore, datum 3, datum 5, and datum 6 are flagged for eviction from initial data list 404 based on the fine granularity provided by the parent holonym flags PHOF, while datum 4 and datum 6 would be evicted based on the coarser granularity provided by the grandparent holonym flag GHOF. Furthermore, datum 6 would certainly be flagged for eviction from initial data list 404 based on the combination holonym flag CHOF.

With reference now to FIG. 5, a high-level flow chart of one or more steps performed by a computer processor to identify errant data entries for eviction from a data list by the use of hypernyms and/or holonyms is presented. After initiator block 502, an initial data list is received by a processor (block 504). Each datum entry in the initial data list is associated with a parent hypernym from a group of multiple parent hypernyms, and the parent hypernym describes a common attribute of data entries in the initial data list that have a same parent hypernym. That is, data entries with a same parent hypernym share a common attribute that is described by the parent hypernym.

As described in block 506, a plurality (i.e., more than any other) parent hypernym used by data entries in the initial data list is identified. The plurality parent hypernym is common to more data entries in the initial data list than any other parent hypernym. In one embodiment, the plurality parent hypernym is a majority (i.e., more than 50%) parent hypernym. In another embodiment, the plurality parent hypernym is any hypernym that occurs more than some predetermined value (i.e., the plurality parent hypernym is associated with more than 95% of items in the initial data list).

As described in block 508, a parent holonym from a group of multiple parent holonyms is associated with each datum entry in the initial data list. Each datum entry in the initial data list describes a component (i.e., meronym) of a parent holonym. The processor then identifies a plurality parent holonym used by the initial data list, where the plurality parent holonym is common to more data entries in the initial data list than any other parent holonym.

As described in block 510, the processor associates a grandparent hypernym with each datum entry in the initial data list, where multiple data entries in the initial data list share a same grandparent hypernym while having different parent hypernyms. The processor then identifies a plurality grandparent hypernym used by the initial data list, where the plurality grandparent hypernym is common to more data entries in the initial data list than any other grandparent hypernym.

As described in block 512, the processor associates a grandparent holonym with each datum entry in the initial data list, where multiple data entries in the initial data list share a same grandparent holonym while having different parent holonyms. The processor then identifies a plurality (i.e., more than any other) grandparent holonym used by the initial data list, where the plurality grandparent holonym is common to more data entries in the initial data list than any other grandparent holonym.

As depicted in block 514, datum entries that are not associated with the plurality parent hypernym, the plurality parent holonym, the plurality grandparent hypernym, and/or the plurality grandparent holonym are then flagged for eviction from the initial data list.

Note that in one embodiment, the level of hypernyms/holonyms is not limited to two (i.e., parent and grandparent), but may be any multiple-order (i.e., parent, grandparent, great grandparent, great-great grandparent, etc.). In this embodiment, the processor associates multiple-order hypernyms with each datum entry in the initial data list, where multiple data entries in the initial data list share a same multiple-order hypernym while having different parent hypernyms. The processor then determines what level of multiple-order hypernyms is to be used to identify related data items in the initial data list (e.g., based on the granularity level that is desired/predetermined to be used). The processor then applies this desired/predetermined level of multiple-order hypernyms to identify the related items in the initial data list.

The process ends at terminator block 516.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A processor-implemented method of identifying errant data in an initial data list, the processor-implemented method comprising:
receiving, by a processor, an initial data list, wherein each datum entry in the initial data list is associated with a parent hypernym from a group of multiple parent hypernyms, and wherein the parent hypernym describes a common attribute of data entries in the initial data list that have a same parent hypernym;
identifying, by the processor, a plurality parent hypernym used by data entries in the initial data list, wherein the plurality parent hypernym is common to more data entries in the initial data list than any other parent hypernym; and
flagging, by the processor, any datum entry in the initial data list that is not associated with the plurality parent hypernym.

2. The processor-implemented method of claim 1, further comprising:
evicting any flagged data entries from the initial data list, wherein flagged data entries are not associated with the plurality parent hypernym.

3. The processor-implemented method of claim 1, further comprising:
associating, by the processor, a grandparent hypernym with each datum entry in the initial data list, wherein multiple data entries in the initial data list share a same grandparent hypernym while having different parent hypernyms;
identifying, by the processor, a plurality grandparent hypernym used by the initial data list, wherein the plurality grandparent hypernym is common to more data entries in the initial data list than any other grandparent hypernym; and
flagging, by the processor, any datum entry in the initial data list that is not associated with the plurality grandparent hypernym.

4. The processor-implemented method of claim 3, further comprising:
evicting any flagged data entries from the initial data list, wherein flagged data entries are not associated with the plurality grandparent hypernym.

5. The processor-implemented method of claim 1, further comprising:
associating, by the processor, a parent holonym from a group of multiple parent holonyms with each datum entry in the initial data list, wherein each datum entry in the initial data list describes a component of the parent holonym;
identifying, by the processor, a plurality parent holonym used by the initial data list, wherein the plurality parent holonym is common to more data entries in the initial data list than any other parent holonym; and
flagging, by the processor, any datum entry in the initial data list that is not associated with the plurality parent hypernym and the plurality parent holonym.

6. The processor-implemented method of claim 5, further comprising:
evicting any flagged data entries from the initial data list, wherein flagged data entries are not associated with the plurality parent hypernym and the plurality parent holonym.

7. The processor-implemented method of claim 5, further comprising:
associating, by the processor, a grandparent holonym with each datum entry in the initial data list, wherein multiple data entries in the initial data list share a same grandparent holonym while having different parent holonyms;
identifying, by the processor, a plurality grandparent holonym used by the initial data list, wherein the plurality grandparent holonym is common to more data entries in the initial data list than any other grandparent holonym; and
flagging, by the processor, any datum entry in the initial data list that is not associated with the plurality grandparent holonym.

8. The processor-implemented method of claim 7, further comprising:
evicting any flagged data entries from the initial data list, wherein flagged data entries are not associated with the plurality grandparent holonym.

9. The processor-implemented method of claim 1, further comprising:
associating, by the processor, multiple-order hypernyms with each datum entry in the initial data list, wherein multiple data entries in the initial data list share a same multiple-order hypernym while having different parent hypernyms;
determining, by the processor, a level of said multiple-order hypernyms to be used to identify related data items in the initial data list; and
applying, by the processor, a determined level of said multiple-order hypernyms to identify the related data items in the initial data list.

10. A computer program product for identifying errant data in an initial data list, the computer program product comprising:
a computer readable storage medium;
first program instructions to receive an initial data list, wherein each datum entry in the initial data list is associated with a parent hypernym from a group of multiple parent hypernyms, and wherein the parent hypernym describes a common attribute of data entries in the initial data list that have a same parent hypernym;
second program instructions to identify a plurality parent hypernym used by data entries in the initial data list, wherein the plurality parent hypernym is common to more data entries in the initial data list than any other parent hypernym; and
third program instructions to flag any datum entry in the initial data list that is not associated with the plurality parent hypernym; and wherein
the first, second, and third program instructions are stored on the computer readable storage medium.

11. The computer program product of claim 10, further comprising:
fourth program instructions to evict any flagged data entries from the initial data list, wherein flagged data entries are not associated with the plurality parent hypernym; and wherein the fourth program instructions are stored on the computer readable storage medium.

12. The computer program product of claim 10, further comprising:
fourth program instructions to associate a grandparent hypernym with each datum entry in the initial data list, wherein multiple data entries in the initial data list share a same grandparent hypernym while having different parent hypernyms;
fifth program instructions to identify a plurality grandparent hypernym used by the initial data list, wherein the plurality grandparent hypernym is common to more data entries in the initial data list than any other grandparent hypernym; and
sixth program instructions to flag any datum entry in the initial data list that is not associated with the plurality grandparent hypernym; and wherein
the fourth, fifth, and sixth program instructions are stored on the computer readable storage medium.

13. The computer program product of claim 12, further comprising:
seventh program instructions to evict any flagged data entries from the initial data list, wherein flagged data entries are not associated with the plurality grandparent hypernym; and
wherein the seventh, eighth, and ninth program instructions are stored on the computer readable storage medium.

14. The computer program product of claim 10, further comprising:
fourth program instructions to associate a parent holonym from a group of multiple parent holonyms with each datum entry in the initial data list, wherein each datum entry in the initial data list describes a component of the parent holonym;
fifth program instructions to identify a plurality parent holonym used by the initial data list, wherein the plurality parent holonym is common to more data entries in the initial data list than any other parent holonym; and
sixth program instructions to flag any datum entry in the initial data list that is not associated with the plurality parent hypernym and the plurality parent holonym; and wherein the fourth, fifth, and sixth program instructions are stored on the computer readable storage medium.

15. The computer program product of claim 14, further comprising:
seventh program instructions to evict any flagged data entries from the initial data list, wherein flagged data entries are not associated with the plurality parent hypernym and the plurality parent holonym; and wherein
the seventh program instructions are stored on the computer readable storage medium.

16. The computer program product of claim 14, further comprising:
seventh program instructions to associate a grandparent holonym with each datum entry in the initial data list, wherein multiple data entries in the initial data list share a same grandparent holonym while having different parent holonym;
eighth program instructions to identify a plurality grandparent holonym used by the initial data list, wherein the plurality grandparent holonym is common to more data entries in the initial data list than any other grandparent holonym; and
ninth program instructions to flag any datum entry in the initial data list that is not associated with the plurality grandparent holonym; and wherein
the seventh, eighth, and ninth program instructions are stored on the computer readable storage medium.

17. The computer program product of claim 16, further comprising:
tenth program instructions to evict any flagged data entries from the initial data list, wherein flagged data entries are not associated with the plurality grandparent holonym; and
wherein the tenth program instructions are stored on the computer readable storage medium.

18. The computer program product of claim 10, further comprising:
fourth program instructions to associate multiple-order hypernyms with each datum entry in the initial data list, wherein multiple data entries in the initial data list share a same multiple-order hypernym while having different parent hypernyms;
fifth program instructions to determine a level of said multiple-order hypernyms to be used to identify related data items in the initial data list; and
sixth program instructions to apply a determined level of said multiple-order hypernyms to identify the related data items in the initial data list; and wherein
the fourth, fifth, and sixth program instructions are stored on the computer readable storage medium.

19. A computer system comprising:
a central processing unit (CPU), a computer readable memory, and a computer readable storage medium;
first program instructions to receive an initial data list, wherein each datum entry in the initial data list is associated with a parent hypernym from a group of multiple parent hypernyms, and wherein the parent hypernym describes a common attribute of data entries in the initial data list that have a same parent hypernym;
second program instructions to identify a plurality parent hypernym used by data entries in the initial data list, wherein the plurality parent hypernym is common to more data entries in the initial data list than any other parent hypernym; and
third program instructions to flag any datum entry in the initial data list that is not associated with the plurality parent hypernym; and wherein
the first, second, and third program instructions are stored on the computer readable storage medium for execution by the CPU via the computer readable memory.

20. The computer system of claim 19, further comprising:
fourth program instructions to evict any flagged data entries from the initial data list, wherein flagged data entries are not associated with the plurality parent hypernym; and wherein the fourth program instructions are stored on the computer readable storage medium for execution by the CPU via the computer readable memory.
